(19) United States
(12) Patent Application Publication
(10) Pub. No.: US 2021/0318563 A1
(43) Pub. Date: Oct. 14, 2021

(54) LIGHT ADJUSTING GLASS

(71) Applicants: Beijing BOE Optoelectronics Technology Co., Ltd., Beijing (CN); BOE TECHNOLOGY GROUP CO., LTD., Beijing (CN)

(72) Inventors: Xiaojuan WU, Beijing (CN); Hongliang YUAN, Beijing (CN); Jian WANG, Beijing (CN)

(21) Appl. No.: 17/262,795

(22) PCT Filed: May 14, 2020
(86) PCT No.: PCT/CN2020/090162

§ 371 Date: Jan. 25, 2021

(30) Foreign Application Priority Data
May 24, 2019 (CN) 201910442105.5

(51) Int. Cl. G02F 1/1347; G02F 1/1343; G02F 1/155; G02F 1/1334

(52) U.S. Cl. CPC G02F 1/1347; G02F 1/13439; G02F 1/155; G02F 2201/16; G02F 1/13347; G02F 2202/04; G02F 2201/44; G02F 1/13345

(57) ABSTRACT

The present disclosure provides a light adjusting glass, including: a basic light adjusting structure and a functional light adjusting structure which are disposed in a laminated manner; the basic light adjusting structure and the functional light adjusting structure are cooperated with each other and configured to control a light transmittance of the light adjusting glass, and the basic light adjusting structure is different from the functional light adjusting structure.

### CROSS-REFERENCE TO RELATED APPLICATIONS

The present application claims the priority of Chinese Patent Application No. 201910442105.5, filed on May 24, 2019, the contents of which are incorporated herein in their entirety by reference.

### TECHNICAL FIELD

The present disclosure relates to the technical field of intelligent glass, and in particular, relates to a light adjusting glass.

### BACKGROUND

At present, light adjusting glasses are more and more widely applied in the fields of building and traffic, and the fields of automobile, high-speed train, passenger aircraft and the like are interest in a light adjusting glass with dye liquid crystal. Products such as PDLC (polymer dispersed liquid crystal) intelligent glass, electro-chromic intelligent glass and the like exist in an intelligent glass market. The PDLC intelligent glass can only realize switching between transparency and haze, and does not block light or heat; the electro-chromic intelligent glass has problems of complex film layer process, slow response speed (8 s to 20 s), bluish color in a dark state and the like. The light adjusting glass with dye liquid crystal realizes switching between a bright state and a dark state by utilizing a selective absorption of dichroic dye molecules in liquid crystal to light, and compared with a conventional PDLC intelligent glass and a conventional electro-chromic intelligent glass, greatly improves optical properties such as black state purity, response speed and the like. However, the existing light adjusting glass with dye liquid crystal can only realize an adjustment between a black state, a bright state and a gray scale state, that is, can only adjust a light transmittance of the glass to visible light. When the light adjusting glass is used to a vehicle window, a meeting room partition and a building glass, the light adjusting glass has a requirement of privacy protection while transmitting light; in the fields of vehicle window, art design and the like, an entire surface of a color light adjusting glass has a great application prospect. The existing light adjusting glass cannot meet such requirements of users.

### SUMMARY

An embodiment of the present disclosure provides a light adjusting glass, including: a basic light adjusting structure and a functional light adjusting structure which are disposed in a laminated manner; where,

the basic light adjusting structure and the functional light adjusting structure are mutually cooperated and configured to control a light transmittance of the light adjusting glass, and the basic light adjusting structure is different from the functional light adjusting structure.

In some implementations, the functional light adjusting structure includes: a first substrate and a second substrate which are disposed opposite to each other; and a first liquid crystal layer interposed between the first substrate and the second substrate; where,

the first liquid crystal layer is configured to be deflected under an action of an electric field generated between the first substrate and the second substrate, so that the functional light adjusting structure is capable of being in a haze state.

In some implementations, the first liquid crystal layer includes PNLC (polymer network liquid crystal) or PDLC.

In some implementations, the PNLC includes a reverse PNLC.

In some implementations, the functional light adjusting structure includes: a first substrate and a second substrate which are disposed opposite to each other; and a first liquid crystal layer interposed between the first substrate and the second substrate; where,

the first liquid crystal layer includes color dye liquid crystal and is configured to be deflected under an action of an electric field generated between the first substrate and the second substrate, so as to control a transmittance of light, with the same color as the color dye liquid crystal, irradiated on the functional light adjusting structure.

In some implementations, the first substrate includes a first base, and a first electrode disposed on a side of the first base proximal to the first liquid crystal layer;

the second substrate includes a second base and a second electrode disposed on a side of the second base proximal to the first liquid crystal layer; where,

the first electrode and the second electrode are both plate-shaped electrodes.

In some implementations, the basic light adjusting structure includes a third substrate, a fourth substrate, and a second liquid crystal layer interposed between the third substrate and the fourth substrate; where,

the second liquid crystal layer includes basic crystal molecules and dichroic dye molecules and is configured to be deflected under the control of an electric field generated between the third substrate and the fourth substrate, so as to control a transmittance of light.

In some implementations, the second liquid crystal layer includes chiral additive therein.

In some implementations, the third substrate includes a third base, and a third electrode disposed on a side of the third base proximal to the second liquid crystal layer;

the fourth substrate includes a fourth base and a fourth electrode disposed on a side of the fourth base proximal to the second liquid crystal layer; where,

the third electrode and the fourth electrode are both plate-shaped electrodes.

In some implementations, the basic light adjusting structure includes a third substrate, a fourth substrate, and an electro-chromic layer interposed between the third substrate and the fourth substrate; where,

the electro-chromic layer controls light to transmit there-through or not under the control of an electric field generated between the third substrate and the fourth substrate.

In some implementations, the functional light adjusting structure includes first base and a second base which are disposed opposite to each other, a first electrode disposed on a side of the first base proximal to the second base, a second electrode disposed on a side of the second base proximal to the first base, and a first liquid crystal layer interposed between the first electrode and the second electrode;

the basic light adjusting structure includes a third base and a fourth base which are disposed opposite to each other, a third electrode disposed on a side of the third base proximal to the fourth base, a fourth electrode disposed on a side of the fourth base proximal to the third base, and a second liquid crystal layer interposed between the third electrode and the fourth electrode; where,

the second base is common to the third base.

In some implementations, the functional light adjusting structure includes a first base and a second base which are disposed opposite to each other, a first electrode disposed on a side of the first base proximal to the second base, a second electrode disposed on a side of the second base proximal to the first base, and a first liquid crystal layer interposed between the first electrode and the second electrode;

the basic light adjusting structure includes a third base and a fourth base which are disposed opposite to each other, a third electrode disposed on a side of the third base proximal to the fourth base, a fourth electrode disposed on a side of the fourth base proximal to the third base, and an electro-chromic layer interposed between the third electrode and the fourth electrode; where,

the second substrate is common to the third substrate.

### DESCRIPTION OF DRAWINGS

FIG. 1 is a schematic structural diagram of a light adjusting glass provided in an embodiment of the present disclosure when a basic light adjusting structure and a functional light adjusting structure are both in a bright state;

FIG. 2 is a schematic structural diagram of a light adjusting glass provided in an embodiment of the present disclosure when a basic light adjusting glass is in a dark state and a functional light adjusting structure is in a haze state;

FIG. 3 is a schematic structural diagram of a light adjusting glass provided in an embodiment of the present disclosure when a basic light adjusting glass is in a bright state and a functional light adjusting structure is in a gray scale state;

FIG. 4 is a schematic structural diagram of a light adjusting glass provided in an embodiment of the present disclosure when a basic light adjusting glass is in a dark state and a functional light adjusting structure is in a gray scale state;

FIG. 5 is a schematic structural diagram of a light adjusting glass provided in an embodiment of the present disclosure when a basic light adjusting structure and a functional light adjusting structure are both in a bright state;

FIG. 6 is a schematic structural diagram of a light adjusting glass provided in an embodiment of the present disclosure when a basic light adjusting glass is in a dark state and a functional light adjusting structure is in a pure color state;

FIG. 7 is a schematic structural diagram of a light adjusting glass provided in an embodiment of the present disclosure when a basic light adjusting glass is in a bright state and a functional light adjusting structure is in a pure color state; and

FIG. 8 is a schematic structural diagram of a light adjusting glass provided in an embodiment of the present disclosure.

### DESCRIPTION OF EMBODIMENTS

In order to make technical solutions of the present disclosure better understood, the technical solutions of the present disclosure are described in further detail below with reference to the accompanying drawings and the detailed description.

Unless defined otherwise, technical or scientific terms used herein shall have the ordinary meaning as understood by one of ordinary skill in the art to which the present disclosure belongs. The use of “first”, “second”, and the like in the present disclosure is not intended to indicate any order, quantity, or importance, but rather is used to distinguish one element from another. Furthermore, the use of terms “a”, “an”, or “the” and similar referents do not denote a limitation of quantity, but rather denote a presence of at least one. The word “including” or “includes”, and the like, is intended to mean that an element or item preceding the word includes an element or item listed after the word and its equivalent, but not an exclusion of other elements or items. The terms “bonding”, “bonded” and the like are not restricted to physical or mechanical bonding, but may include electrical bonding, whether direct or indirect. Terms “upper”, “lower”, “left”, “right”, and the like are used only to indicate relative positional relationships, and when an absolute position of an object being described is changed, the relative positional relationships may also be changed accordingly.

An embodiment of the present disclosure provides a light adjusting glass, including a basic light adjusting structure and a functional light adjusting structure disposed in a laminated manner, where the basic light adjusting structure and the functional light adjusting structure are cooperated with each other and are configured to control a light transmittance of the light adjusting glass.

In related art, the light adjusting glass usually includes only one light adjusting structure for adjusting a transmittance of light; and the light adjusting glass provided in the embodiment of the present disclosure includes a basic light adjusting glass and a functional light adjusting glass, that is, includes two light adjusting structures, and these two light adjusting structures are both capable of adjusting the transmittance of light, by adopting these two light adjusting structures to adjust the transmittance of light, more accurate adjustment can be realized.

The following describes how the light adjusting glass provided in the embodiment of the present disclosure realizes adjustment of the transmittance of light.

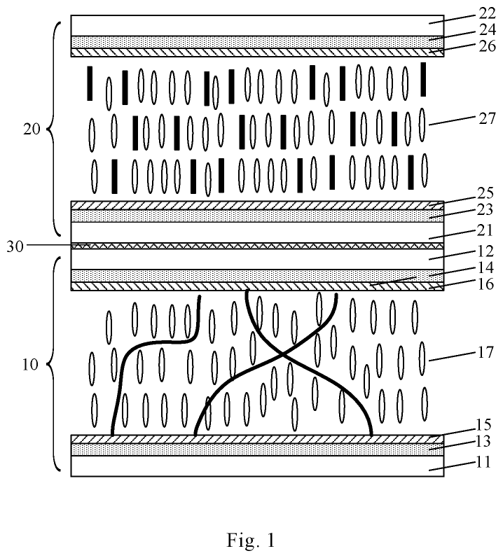

As shown in FIGS. 1 to 4, an embodiment of the present disclosure provides a light adjusting glass with a privacy protecting function, which includes a basic light adjusting structure 20 and a functional light adjusting structure 10 disposed in a laminated mode; the basic light adjusting structure 20 and the functional light adjusting structure 10 are bonded together by an adhesive layer 30, and both the basic light adjusting structure 20 and the functional light adjusting structure 10 are liquid crystal cell structures.

Specifically, the functional light adjusting structure 10 includes: a first substrate and a second substrate which are disposed opposite to each other; and a first liquid crystal layer 17 interposed between the first substrate and the second substrate; the first liquid crystal layer 17 is configured to be deflected under an action of an electric field generated between the first substrate and the second substrate, so that the functional light adjusting structure 10 is capable of being in a haze state; certainly, the functional light adjusting structure 10 is also capable of being in a bright state or a gray scale state under an action of different electric fields between the first substrate and the second substrate. Here, the haze state in the embodiment refers to a state in which light is scattered; when the functional light adjusting structure 10 is in the haze state, light can be scattered, so that an object on a side of the second substrate cannot be seen from a side of the first substrate, and similarly, an object on a side of the first substrate cannot be seen from a side of the second substrate, thereby achieving an effect of privacy protection.

More specifically, the first substrate of the functional light adjusting structure 10 may include a first base 11, a first electrode 13 and a first alignment layer 15 sequentially disposed on the first base 11; the second substrate of the functional light adjusting structure 10 is disposed opposite to the first substrate, and the second substrate may include a second base 12, and a second electrode 14 and a second alignment layer 16 sequentially disposed on a side of the second base 12 proximal to the first base 11; a first liquid crystal layer 17 is interposed between the first alignment layer 15 and the second alignment layer 16, and the first liquid crystal layer 17 may specifically include PNLC (polymer network liquid crystal) or PDLC (polymer dispersed liquid crystal). The first electrode 13 and the second electrode 14 each may be a plate-shaped electrode, that is, the functional light adjusting structure 10 may be a VA (vertical alignment) type liquid crystal cell structure, and in such case, the first liquid crystal layer 17 may include reserve PNLC, which will be taken as an example for further describing below.

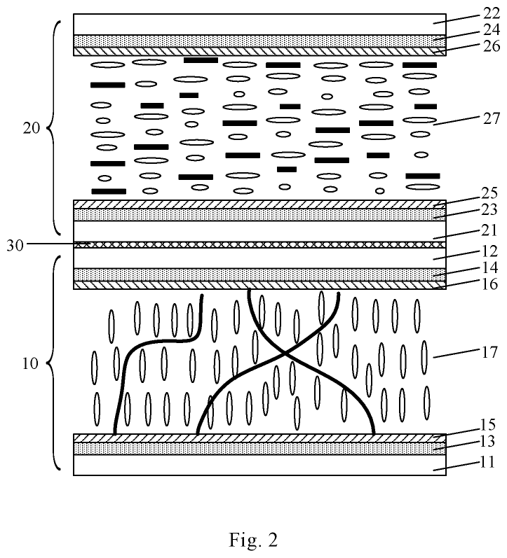

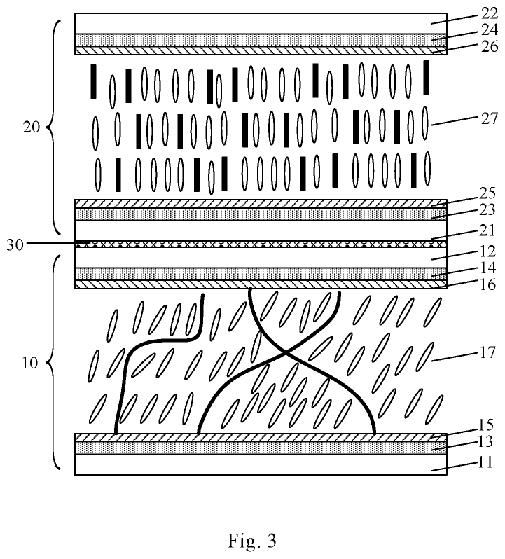

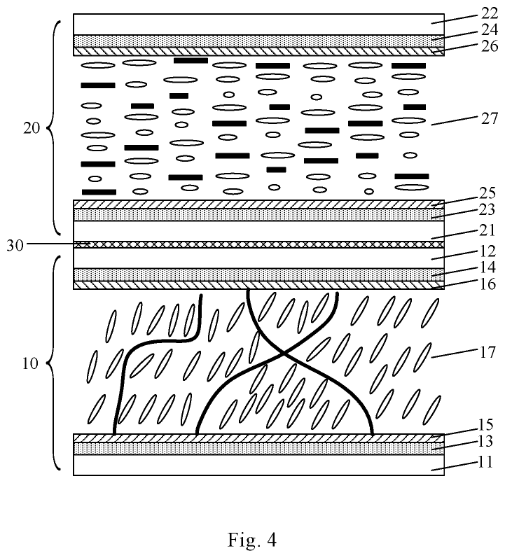

When no voltage is applied to the first electrode 13 and the second electrode 14, there is no electric field between the first electrode 13 and the second electrode 14, a refractive index of liquid crystal molecules along a short axis thereof matches a refractive index nₚ of polymer in the reverse PNLC, for example nₚ=n₀, light can transmit through the functional light adjusting structure 10, and the functional light adjusting structure 10 is in the bright state, as shown by the functional light adjusting structure 10 in FIGS. 1 and 2; when a voltage is applied between the first electrode 13 and the second electrode 14 to generate an electric field between the first electrode 13 and the second electrode 14 so that the liquid crystal molecules in the reverse PNLC are deflected, and a difference between the refractive index nₚ of polymer in the reverse PNLC and a refractive index nₑ of the liquid crystal molecules along a long axis thereof is the largest, the functional light adjusting structure 10 is in the haze state, as shown by the functional light adjusting structure 10 in FIGS. 3 and 4; when a voltage is applied between the first electrode 13 and the second electrode 14 so that the liquid crystal molecules in the reverse PNLC are deflected, and a difference exists between the refractive index nₚ of polymer in the reverse PNLC and the refractive index nₑ of the liquid crystal molecules along the long axis thereof, but the difference is not the largest, the functional light adjusting structure 10 is in the gray scale state.

The basic light adjusting structure 20 includes: a third substrate and a fourth substrate which are disposed opposite to each other; and a second liquid crystal layer 27 interposed between the third substrate and the fourth substrate; where the second liquid crystal layer 27 is configured to be deflected under the control of an electric field generated between the third substrate and the fourth substrate, so as to control a transmittance of light transmitting through the second liquid crystal layer 27.

Specifically, the third substrate of the basic light adjusting structure 20 may include a third base 21, a third electrode 23 and a third alignment layer 25 sequentially disposed on the third base 21; the fourth substrate of the basic light adjusting structure 20 may include a fourth base 22 disposed opposite to the third base 21, and a fourth electrode 24 and a fourth alignment layer 26 sequentially disposed on a side of the fourth base 22 proximal to the third base 21; the second liquid crystal layer 27 is interposed between the third alignment layer 25 and the fourth alignment layer 26; where the second liquid crystal layer 27 includes dye liquid crystal, i.e., liquid crystal molecules and doped dichroic dye molecules. The third electrode 23 and the fourth electrode 24 each may be a plate-shaped electrode, that is, the basic light adjusting structure 20 may be a VA-type liquid crystal cell. Alignment directions of the third alignment layer 25 and the fourth alignment layer 26 are parallel, and when no voltage is applied to the third electrode 23 and the fourth electrode 24, the liquid crystal molecules and the dichroic dye molecules in the second liquid crystal layer 27 are oriented perpendicular to the third substrate and the fourth substrate, so that incident light can transmit there-through, and the basic light adjusting structure 20 is in the bright state, as shown by the basic light adjusting structure 20 in FIGS. 1 and 3; when a voltage is applied between the third electrode 23 and the fourth electrode 24, an electric field is generated between the third electrode 23 and the fourth electrode 24, the liquid crystal molecules and the dichroic dye molecules are controlled to be oriented parallel to the third substrate and the fourth substrate, the incident light along a direction of long axis of the dichroic dye molecules is absorbed, and the basic light adjusting structure 20 is in the dark state, as shown by the basic light adjusting structure 20 in FIGS. 2 and 4. Certainly, when a voltage is applied between the third electrode 23 and the fourth electrode 24, the electric field generated between the third electrode 23 and the fourth electrode 24 may control the liquid crystal molecules and the dichroic dye molecules to be oriented at an acute angle or an obtuse angle with respect to the first substrate and the second substrate, and in such case, a portion of light can transmit through the basic light adjusting structure 20, so that the basic light adjusting structure 20 is in the gray scale state.

In order to reduce the transmittance of the basic light adjusting structure 20 in the dark state and thereby increase the contrast ratio, chiral additive may be included in the second liquid crystal layer 27.

Table 1 shows corresponding states of the light adjusting glass when the functional light adjusting structure 10 is in the bright state, the gray scale state, and the haze state respectively, and the basic light adjusting structure 20 is in the bright state, the dark state, and the gray scale state respectively.

TABLE 1

| | | | | | |
|---|---|---|---|---|---|
| light adjusting | bright | grey scale | dark | dark | privacy |
| glass | state | state | state 1 | state 2 | protection |
| | | | | | state |
| basic light | bright | grey scale | dark | dark | bright |
| adjusting | state | state | state | state | state |
| structure | | | | | |
| functional light | bright | grey scale | bright | haze | haze |
| adjusting structure | state | state | state | state | state |

It should be noted that, the dark state 1 and the dark state 2 in the table 1 both represent that the light adjusting glass is in the dark state, and only reasons why the light adjusting glass is in the dark state are different, that is, in the dark state 1, the basic light adjusting structure 20 is in the dark state, and the functional light adjusting structure 10 is in the bright state; and in the dark state 2, the basic light adjusting structure 20 is in the dark state, and the functional light adjusting structure 10 is in the haze state.

The basic light adjusting structure 20 and the functional light adjusting structure 10 in FIG. 1 are both in the bright state, and thus the light adjusting glass is in the bright state; the basic light adjusting structure 20 in FIG. 2 is in the dark state, and the functional light adjusting structure 10 in FIG. 2 is in the bright state, and thus the light adjusting glass is in the dark state; the basic light adjusting structure 20 in FIG. 3 is in the bright state, and the functional light adjusting structure 10 in FIG. 3 is in the haze state, and thus the light adjusting glass is in a privacy protection state; the basic light adjusting structure 20 in FIG. 4 is in the dark state, and the functional light adjusting structure 10 in FIG. 4 is in the haze state, and thus the light adjusting glass is in the dark state.

Therefore, it can be seen that, by a cooperation of the basic light adjusting structure 20 and the functional light adjusting structure 10 mutually, the light adjusting glass in the embodiment not only can realize different light transmittances, but also can be in the privacy protection state when the basic light adjusting glass is in the bright state and the functional light adjusting glass is in the haze state, and therefore, structures such as a vehicle window, a glass partition and a building glass using the light adjusting glass can realize a function of privacy protection, and further improve user's experiences.

In the embodiment, when the basic light adjusting structure 20 adopts the above liquid crystal cell structure, a cell thickness thereof ranges from 3.5 μm to 30 μm, and the specific cell thickness can be adjusted according to the light transmittance of the light adjusting glass.

In the embodiment, when the functional light adjusting structure 10 adopts the above liquid crystal cell structure, a cell thickness thereof ranges from 5 μm to 15 μm, and the specific cell thickness can be adjusted according to the light transmittance of the light adjusting glass.

Correspondingly, an embodiment of the present disclosure provides a method for manufacturing the above light adjusting glass. The method includes a step of forming the basic light adjusting structure 20 and the functional light adjusting structure 10, respectively, and a step of bonding the basic light adjusting structure 20 and the functional light adjusting structure 10 together.

In some implementations, the method for manufacturing the basic light adjusting structure 20 may specifically include the following steps S11 to S13.

S11, forming electrodes on entire surfaces of the third base 21 and the fourth base 22, that is, forming the third electrode 23 on the third base 21 and forming the fourth electrode 24 on the fourth base 22.

S12, sequentially coating PI (polyimide) liquid and performing a rubbing process on the third electrode 23 and the fourth electrode 24 to form a third alignment layer 25 and a fourth alignment layer 26; where rubbing directions of the third alignment layer 25 and the fourth alignment layer 26 are antiparallel, and the PI liquid is a VA type PI liquid SE-5661.

S13, coating frame sealing glue on the fourth base 22 formed with the fourth alignment layer 26, mixing liquid crystal molecules with dichroic dye molecules to form black dye liquid crystal, and dropping the black dye liquid crystal on the third alignment layer 25; then, aligning and assembling the third base 21 and the fourth base 22 to form a liquid crystal cell, and curing the frame sealing glue through ultraviolet light and heat to form the basic light adjusting structure 20; where the frame sealing glue is SWB101, the liquid crystal molecules are MDA-18-2030, and a cell thickness of the liquid crystal cell of the basic light adjusting structure 20 is 3.5 μm.

The method for manufacturing the functional light adjusting structure 10 may specifically include the following steps S21 to S23.

S21, forming electrodes on entire surfaces of the first base 11 and the second base 12, that is, forming the first electrode 13 on the first base 11 and forming the second electrode 14 on the second base 12.

S22, sequentially coating PI liquid and performing a rubbing process on the first electrode 13 and the second electrode 14 to form a first alignment layer 15 and a second alignment layer 16; where rubbing directions of the first alignment layer 15 and the second alignment layer 16 are antiparallel; the PI liquid is VA type PI liquid SE-5661.

S23, coating frame sealing glue on the second base 12 formed with the second alignment layer 16, and dropping PNLC on the first alignment layer 15; then, aligning and assembling the first base 11 and the second base 12 to form a liquid crystal cell, and curing the frame sealing glue through ultraviolet light and heat to form the functional light adjusting structure 10; where the frame sealing glue is SWB101, the liquid crystal molecules are STY005-017-P002, and a cell thickness of the liquid crystal cell of the functional light adjusting structure 10 is 3.5 μm.

The step of bonding the basic light adjusting structure 20 and the functional light adjusting structure 10 together may include: bonding the third base 21 of the basic light adjusting structure 20 to the second base 12 of the formed functional light adjusting structure 10 by adopting a bonding assembly process to from the light adjusting glass with the function of privacy protection. The light transmittance of the light adjusting glass in the dark state can reach 15%, the light transmittance of the light adjusting glass in the bright state can reach 65%, the light transmittance of the light adjusting glass in the privacy protection state can reach 36%, and the light transmittance of the light adjusting glass in the haze state can reach 75%.

In some implementations, the method for manufacturing the basic light adjusting structure 20 may specifically include the following steps S11′ to S13′.

S11′, forming electrodes on entire surfaces of the third base 21 and the fourth base 22, that is, forming the third electrode 23 on the third base 21, and forming the fourth electrode 24 on the fourth base 22, respectively.

S12′, sequentially coating PI liquid and performing a rubbing process on the third electrode 23 and the fourth electrode 24 to form a third alignment layer 25 and a fourth alignment layer 26; where rubbing directions of the third alignment layer 25 and the fourth alignment layer 26 are antiparallel; and the PI liquid is VA type PI liquid SE-4804.

S13′, coating frame sealing glue on the fourth base 22 formed with the fourth alignment layer 26, mixing liquid crystal molecules with dichroic dye molecules to form black dye liquid crystal, and dropping the black dye liquid crystal on the third base 21 formed with the third alignment layer 25; then, aligning and assembling the third base 21 and the fourth base 22 to form a liquid crystal cell, and curing the frame sealing glue through ultraviolet light and heat to form the basic light adjusting structure 20; where the frame sealing glue is SWB73, the liquid crystal molecules are BOE-841036, and a cell thickness of the liquid crystal cell of the basic light adjusting structure 20 is 9 μm.

The method for manufacturing the functional light adjusting structure 10 may specifically include the following steps S21′ to S23′.

S21′, forming electrodes on entire surfaces of the first base 11 and the second base 12, respectively, that is, forming the first electrode 13 on the first base 11, and forming the second electrode 14 on the second base 12.

S22′, sequentially coating PI liquid and performing a rubbing process on the first electrode 13 and the second electrode 14 to form a first alignment layer 15 and a second alignment layer 16; where rubbing directions of the first alignment layer 15 and the second alignment layer 16 are antiparallel; the PI liquid is VA type PI liquid SE-4804.

S23′, coating frame sealing glue on the second base 12 formed with the second alignment layer 16, and dropping PNLC on the first alignment layer 15; then, aligning and assembling the first base 11 and the second base 12 to form a liquid crystal cell, and curing the frame seal glue through ultraviolet light and heat to form the functional light adjusting structure 10; where the frame sealing glue is SWB73, the liquid crystal molecules are STY005-017-P005, and a cell thickness of the liquid crystal cell of the functional light adjusting structure 10 is 6 μm.

The step of bonding the basic light adjusting structure 20 and the functional light adjusting structure 10 together may include: bonding the third base 21 of the basic light adjusting structure 20 to the second base 12 of the formed functional light adjusting structure 10 by adopting a bonding assembly process to form the light adjusting glass with the function of privacy protection. The light transmittance of the light adjusting glass in the dark state can reach 3.5%, the light transmittance of the light adjusting glass in the bright state can reach 38%, the light transmittance of the light adjusting glass in the privacy protection state can reach 22%, and the light transmittance of the light adjusting glass in the haze state can reach 75%.

In some implementations, the method for manufacturing the basic light adjusting structure 20 may specifically include the following steps S11″ to S31″.

S11″, forming electrodes on entire surfaces of the third base 21 and the fourth base 22, that is, forming the third electrode 23 on the third base 21, and forming the fourth electrode 24 on the fourth base 22.

S12″, sequentially coating PI liquid and performing a rubbing process on the third electrode 23 and the fourth electrode 24 to form a third alignment layer 25 and a fourth alignment layer 26; where rubbing directions of the third alignment layer 25 and the fourth alignment layer 26 are antiparallel; and the PI liquid is VA type PI liquid DL-4018.

S13″, coating frame sealing glue on the fourth base 22 formed with the fourth alignment layer 26, mixing liquid crystal molecules with dichroic dye molecules to form black dye liquid crystal, and dropping the black dye liquid crystal on the third alignment layer 25; then, aligning and assembling the third base 21 and the fourth base 22 to form a liquid crystal cell, and curing the frame sealing glue through ultraviolet light and heat to form the basic light adjusting structure 20; where the frame sealing glue is SWB73, the liquid crystal molecules are BOE-841036, and a cell thickness of the liquid crystal cell of the basic light adjusting structure 20 is 30 μm.

The method for manufacturing the functional light adjusting structure 10 may specifically include the following steps S21″ to S23″.

S21″, forming electrodes on entire surfaces of the first base 11 and the second base 12, that is, forming the first electrode 13 on the first base 11, and forming he second electrode 14 on the second base 12.

S22″, sequentially coating PI liquid and performing a rubbing process on the first electrode 13 and the second electrode 14 to form a first alignment layer 15 and a second alignment layer 16; where rubbing directions of the first alignment layer 15 and the second alignment layer 16 are antiparallel; and the PI liquid is VA type PI liquid DL-4018.

S23″, coating frame sealing glue on the second base 12 formed with the second alignment layer 16, and dropping PNLC on the first alignment layer 15; then, aligning and assembling the first base 11 and the second base 12 to form a liquid crystal cell, and curing the frame sealing glue through ultraviolet light and heat to form the functional light adjusting structure 10; where the frame sealing glue is SWB73, the liquid crystal molecules are STY005-017-P005, and a cell thickness of the liquid crystal cell of the functional light adjusting structure 10 is 20 μm.

The step of bonding the basic light adjusting structure 20 and the functional light adjusting structure 10 together may include: bonding the third base 21 of the basic light adjusting structure 20 to the second base 12 of the functional light adjusting structure 10 by adopting a bonding assembly process to form the light adjusting glass with the function of privacy protection. The light transmittance of the light adjusting glass in the dark state can reach 0.5%, the light transmittance of the light adjusting glass in the bright state can reach 20%, the light transmittance of the light adjusting glass in the privacy protection state can reach 15%, and the light transmittance of the light adjusting glass in the haze state can reach 75%.

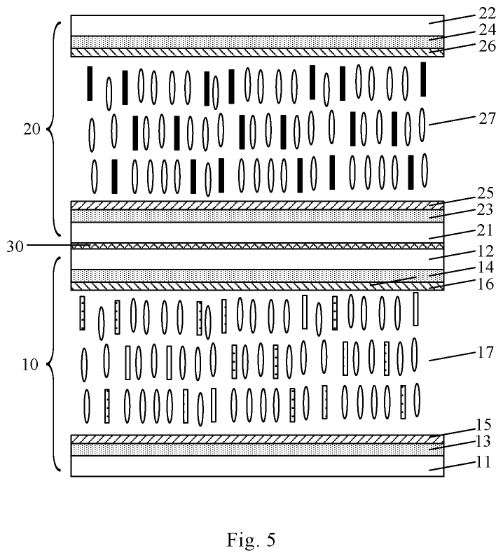

As shown in FIGS. 5 to 7, an embodiment of the present disclosure provides a light adjusting glass with a color light adjusting function, which includes a basic light adjusting structure 20 and a functional light adjusting structure 10 which are disposed in a laminated mode; the basic light adjusting structure 20 and the functional light adjusting structure 10 are bonded together by an adhesive layer 30, and both the basic light adjusting structure 20 and the functional light adjusting structure 10 are liquid crystal cell structures.

Specifically, the basic light adjusting structure 20 in the present embodiment may adopt the same structure as that in the above embodiment, and therefore, the description thereof is not repeated herein.

The functional light adjusting structure 10 may include: a first substrate and a second substrate which are disposed opposite to each other, and a first liquid crystal layer 17 interposed between the first substrate and the second substrate; the first liquid crystal layer 17 includes color dye liquid crystal, and is configured to be deflected under an action of an electric field generated between the first substrate and the second substrate, so that the functional light adjusting structure 10 is capable of being in a pure color state; certainly, the functional light adjusting structure 10 may also be in a bright state, a dark state or a gray scale state under an action of different electric fields between the first substrate and the second substrate.

Specifically, the first substrate of the functional light adjusting structure 10 may include a first base 11, a first electrode 13 and a first alignment layer 15 sequentially disposed on the first base 11; the second substrate of the functional light adjusting structure 10 is disposed opposite to the first substrate, and the second substrate includes a second base 12, and a second electrode 14 and a second alignment layer 16 sequentially disposed on a side of the second base 12 proximal to the first base 11; the first liquid crystal layer 17 is interposed between the first alignment layer 15 and the second alignment layer 16; the first liquid crystal layer 17 may specifically include color dye liquid crystal, that is, liquid crystal molecules and mixed dichroic dye molecules. The first electrode 13 and the second electrode 14 each may be a plate-shaped electrode, that is, the functional light adjusting structure 10 may be a VA-type liquid crystal cell.

When no voltage is applied between the first electrode 13 and the second electrode 14, the liquid crystal molecules and the dichroic dye molecules in the color dye liquid crystal between the first electrode 13 and the second electrode 14 are oriented perpendicular to the first base 11 and the second base 12, and in such case, light may transmit through the functional light adjusting structure 10, and the functional light adjusting structure 10 is in the bright state, as shown by the functional light adjusting structure 10 in FIG. 5; when a voltage is applied between the first electrode 13 and the second electrode 14, an electric field is generated between the first electrode 13 and the second electrode 14, and the liquid crystal molecules and the dichroic dye molecules in the color dye liquid crystal are controlled to be deflected and oriented parallel to the first base 11 and the second base 12, and thus the functional light adjusting structure 10 is in the pure color state; when a voltage is applied between the first electrode 13 and the second electrode 14, and an electric field generated between the first electrode 13 and the second electrode 14 can also control the liquid crystal molecules and the dichroic dye molecules in the color dye liquid crystal to deflect and orient at an acute angle or an obtuse angle with respect to the first base 11 and the second base 12, the functional light adjusting structure 10 is in the gray scale state.

Table 2 shows corresponding states of the light adjusting glass when the functional light adjusting structure 10 is in the bright state, the gray scale state, the dark state, and the pure color state respectively, and the basic light adjusting structure 20 is in the bright state, the dark state, and the gray scale state respectively.

TABLE 2

| | | | | |
|---|---|---|---|---|
| light adjusting | bright | grey scale | dark | pure color |
| glass | state | state | state | state |
| basic light | bright | grey scale | dark | dark |
| adjusting | state | state | state | state |
| structure | | | | |
| functional light | bright | grey scale | dark | pure color |
| adjusting structure | state | state | state | state |

Therefore, it can be seen that, by a cooperation of the basic light adjusting structure 20 and the functional light adjusting structure 10 mutually, the light adjusting glass in the embodiment not only can realize different light transmittances, but also can be colored when the basic light adjusting glass is in the bright state and the functional light adjusting glass is in the pure color state.

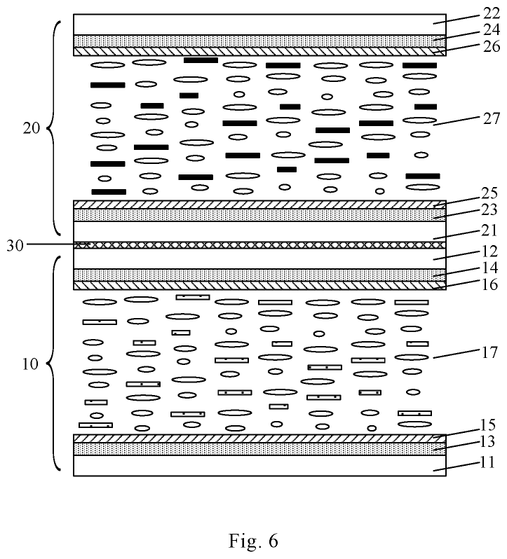

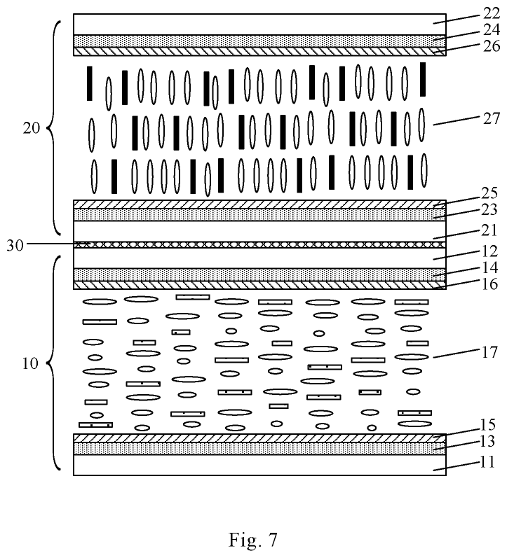

The basic light adjusting structure 20 and the functional light adjusting structure 10 in FIG. 5 are both in the bright state, and thus the light adjusting glass is in the bright state; the basic light adjusting structure in FIG. 6 is in the dark state, and the functional light adjusting structure 10 in FIG. 6 is in the pure color state, and thus the light adjusting glass is in the dark state; the basic light adjusting structure 20 in FIG. 7 is in the bright state, and the functional light adjusting structure 10 in FIG. 7 is in the pure color state, and thus the light adjusting glass is in the pure color state.

Correspondingly, an embodiment of the present disclosure provides a method for manufacturing the above light adjusting glass. The method includes a step of forming the basic light adjusting structure 20 and the functional light adjusting structure 10, respectively, and a step of bonding the basic light adjusting structure 20 and the functional light adjusting structure 10 together.

In some implementations, the method for manufacturing the basic light adjusting structure 20 may specifically include the following steps S111 to S113.

S111, forming electrodes on entire surfaces of the third base 21 and the fourth base 22, that is, forming the third electrode 23 on the third base 21 and forming the fourth electrode 24 on the fourth base 22.

S112, sequentially coating PI liquid and performing a rubbing process on the third electrode 23 and the fourth electrode 24 to form a third alignment layer 25 and a fourth alignment layer 26; where rubbing directions of the third alignment layer 25 and the fourth alignment layer 26 are antiparallel; and the PI liquid is VA type PI liquid SE-5661.

S113, coating frame sealing glue on the fourth base 22 formed with the fourth alignment layer 26, mixing liquid crystal molecules with dichroic dye molecules to form black dye liquid crystal, and dropping the black dye liquid crystal on the third alignment layer 25; then, aligning and assembling the third base 21 and the fourth base 22 to form a liquid crystal cell, and curing the frame sealing glue through ultraviolet light and heat to form the basic light adjusting structure 20; where the frame sealing glue is SWB101, the liquid crystal molecules are MDA-18-2030, and a cell thickness of the liquid crystal cell of the basic light adjusting structure 20 is 3.5 μm.

The method for manufacturing the functional light adjusting structure 10 may specifically include the following steps S221 to S223.

S221, forming electrodes on entire surfaces of the first base 11 and the second base 12, that is, forming the first electrode 13 on the first base 11, and forming the second electrode 14 on the second base 12.

S222, sequentially coating PI liquid and performing a rubbing process on the first electrode 13 and the second electrode 14 to form a first alignment layer 15 and a second alignment layer 16; where rubbing directions of the first alignment layer 15 and the second alignment layer 16 are antiparallel; and the PI liquid is VA type PI liquid SE-5661.

S223, coating the frame sealing glue on the second base 12 formed with the second alignment layer 16, and dropping red dye liquid crystal on the first alignment layer 25; then, aligning and assembling the first base 11 and the second base 12 to form a liquid crystal cell, and curing the frame sealing glue through ultraviolet light and heat to form the functional light adjusting structure 10; where the frame sealing glue is SWB101, the liquid crystal molecules are HNG756100-000, and a cell thickness of the liquid crystal cell of the functional light adjusting structure 10 is 6 μm.

The step of bonding the basic light adjusting structure 20 and the functional light adjusting structure 10 together may include: bonding the third base 21 of the basic light adjusting structure 20 to the second base 12 of the functional light adjusting structure 10 by adopting a bonding assembly process to form the light adjusting glass with a color display function. The light transmittance of the light adjusting glass in the dark state can reach 13%, the light transmittance of the light adjusting glass in the bright state can reach 50%, and a transmittance of red light of the light adjusting glass can reach 32%.

In some implementations, the method for manufacturing the basic light adjusting structure 20 may specifically include the following steps S111′ to S113′.

S111′, forming electrodes on entire surfaces of the third base 21 and the fourth base 22, that is, forming the third electrode 23 on the third base 21 and forming the fourth electrode 24 on the fourth base 22, respectively.

S112′, sequentially coating PI liquid coating and performing a rubbing process on the third electrode 23 and the fourth electrode 24 to form a third alignment layer 25 and a fourth alignment layer 26; where rubbing directions of the third alignment layer 25 and the fourth alignment layer 26 are antiparallel; and the PI liquid is VA type PI liquid DL-4018.

S113′, coating frame sealing glue on the fourth base 22 formed with the fourth alignment layer 26, mixing liquid crystal molecules with dichroic dye molecules to form black dye liquid crystal, and dropping the black dye liquid crystal on the third alignment layer 25; then, aligning and assembling the third base 21 and the fourth base 22 to form a liquid crystal cell, and curing the frame sealing glue through ultraviolet light and heat to form the basic light adjusting structure 20; where the frame sealing glue is SWB73, the liquid crystal molecules are BOE-841036, and a cell thickness of the liquid crystal cell of the basic light adjusting structure 20 is 6 μm.

The method for manufacturing the functional light adjusting structure 10 may specifically include the following steps S221′ to S223′.

S221′, forming electrodes on entire surfaces of the first base 11 and the second base 12, that is, forming the first electrode 13 on the first base 11, and forming the second electrode 14 on the second base 12.

S222′, sequentially coating PI liquid and performing a rubbing process on the first electrode 13 and the second electrode 14 to form a first alignment layer 15 and a second alignment layer 16; where rubbing directions of the first alignment layer 15 and the second alignment layer 16 are antiparallel; and the PI liquid is VA type PI liquid DL-4018.

S223′, coating frame sealing glue on the second base 12 formed with the second alignment layer 16, and dropping red dye liquid crystal on the first alignment layer 25; then, aligning and assembling the first base 11 and the second base 12 to form a liquid crystal cell, and curing the frame sealing glue through ultraviolet light and heat to form the functional light adjusting structure 10; where the frame sealing glue is SWB73, the liquid crystal molecules are HNG756100-002, and a cell thickness of the liquid crystal cell of the functional light adjusting structure 10 is 9 μm.

The step of bonding the basic light adjusting structure 20 and the functional light adjusting structure 10 together may include: bonding the third base 21 of the basic light adjusting structure 20 to the second base 12 of the functional light adjusting structure 10 by adopting a bonding assembly process to form the light adjusting glass with a color display function. The light transmittance of the light adjusting glass in the dark state can reach 4.5%, the light transmittance of the light adjusting glass in the bright state can reach 43%, and a transmittance of red light of the light adjusting glass can reach 25%.

In some implementations, the method for manufacturing the basic light adjusting structure 20 may specifically include the following steps S111″ to S113″.

S111″, forming electrodes on entire surfaces of the third base 21 and the fourth base 22, that is, forming the third electrode 23 on the third base 21, and forming the fourth electrode 24 on the fourth base 22.

S112″, sequentially coating PI liquid and performing a rubbing process on the third electrode 23 and the fourth electrode 24 to form a third alignment layer 25 and a fourth alignment layer 26; where rubbing directions of the third alignment layer 25 and the fourth alignment layer 26 are antiparallel; and the PI liquid is VA type PI liquid SE-5661.

S113″, coating frame sealing glue on the fourth base 22 formed with the fourth alignment layer 26, mixing liquid crystal molecules with dichroic dye molecules to form black dye liquid crystal, and dropping the black dye liquid crystal on the third alignment layer 25; then, aligning and assembling the third base 21 and the fourth base 22 to form a liquid crystal cell, and curing the frame sealing glue through ultraviolet light and heat to form the basic light adjusting structure 20; where the frame sealing glue is SWB101, the liquid crystal molecules are MDA-18-2030, and a cell thickness of the liquid crystal cell of the basic light adjusting structure 20 is 3.5 μm.

The method for manufacturing the functional light adjusting structure 10 may specifically include the following steps S221″ to S223″.

S221″, forming electrodes on entire surfaces of the first base 11 and the second base 12, that is, forming the first electrode 13 on the first base 11, and forming the second electrode 14 on the second base 12.

S222″, sequentially coating PI liquid and performing a rubbing process on the first electrode 13 and the second electrode 14 to form a first alignment layer 15 and a second alignment layer 16; where rubbing directions of the first alignment layer 15 and the second alignment layer 16 are antiparallel; and the PI liquid is VA type PI liquid SE-5661.

S223″, coating frame sealing glue on the second base 12 formed with the second alignment layer 16, and dropping orange dye liquid crystal on the first alignment layer 15; then, aligning and assembling the first base 11 and the second base 12 to form a liquid crystal cell, and curing the frame sealing glue through ultraviolet light and heat to form the functional light adjusting structure 10; where the frame sealing glue is SWB101, the liquid crystal molecules are HNG756100-002, and a cell thickness of the liquid crystal cell of the functional light adjusting structure 10 may be 6 μm.

The step of bonding the basic light adjusting structure 20 and the functional light adjusting structure 10 together may include: bonding the third base 21 of the basic light adjusting structure 20 to the second base 12 of the functional light adjusting structure 10 by adopting a bonding assembly process to form the light adjusting glass with a color display function. The light transmittance of the light adjusting glass in the dark state can reach 17%, the light transmittance of the light adjusting glass in the bright state can reach 58%, and a transmittance of red light of the light adjusting glass can reach 46%.

In some implementations, the method for manufacturing the basic light adjusting structure 20 may specifically include the following steps S1111 to S1113.

S1111, forming electrodes on entire surfaces of the third base 21 and the fourth base 22, that is, forming the third electrode 23 on the third base 21 and forming the fourth electrode 24 on the fourth base 22.

S1112, sequentially coating PI liquid and performing a rubbing process on the third electrode 23 and the fourth electrode 24 to form a third alignment layer 25 and a fourth alignment layer 26; where rubbing directions of the third alignment layer 25 and the fourth alignment layer 26 are antiparallel; and the PI liquid is VA type PI liquid DL-4018.

S1113, coating frame sealing glue on the fourth base 22 formed with the fourth alignment layer 26, mixing liquid crystal molecules with dichroic dye molecules to form black dye liquid crystal, and dropping the black dye liquid crystal on the third alignment layer 25; then, aligning and assembling the third base 21 and the fourth base 22 to form a liquid crystal cell, and curing the frame sealing glue through ultraviolet light and heat to form the basic light adjusting structure 20; where the frame sealing glue is SWB73, the liquid crystal molecules are BOE-841036, and a cell thickness of the liquid crystal cell of the basic light adjusting structure 20 is 6 μm.

The method for manufacturing the functional light adjusting structure 10 may specifically include the following steps S2221 to S2223.

S2221, forming electrodes on entire surfaces of the first base 11 and the second base 12, that is, forming the first electrode 13 on the first base 11 and forming the second electrode 14 on the second base 12.

S2222, sequentially coating PI liquid and performing a rubbing process on the first electrode 13 and the second electrode 14 to form a first alignment layer 15 and a second alignment layer 16; where rubbing directions of the first alignment layer 15 and the second alignment layer 16 are antiparallel; and the PI liquid is VA type PI liquid DL-4018.

S2223, coating frame sealing glue on the second base 12 formed with the second alignment layer 16, and dropping orange dye liquid crystal on the first alignment layer 15; then, aligning and assembling the first base 11 and the second base 12 to form a liquid crystal cell, and curing the frame sealing glue through ultraviolet light and heat to form the functional light adjusting structure 10; where the frame sealing glue is SWB73, the liquid crystal molecules are HNG756100-002, and a cell thickness of the liquid crystal cell of the functional light adjusting structure 10 is 9 μm.

The step of bonding the basic light adjusting structure 20 and the functional light adjusting structure 10 together may include: bonding the third base 21 of the basic light adjusting structure 20 to the second base 12 of the functional light adjusting structure 10 by adopting a bonding assembly process to form the light adjusting glass with a color display function. The light transmittance of the light adjusting glass in the dark state can reach 8.5%, the light transmittance of the light adjusting glass in the bright state can reach 50%, and a transmittance of red light of the light adjusting glass can reach 38%.

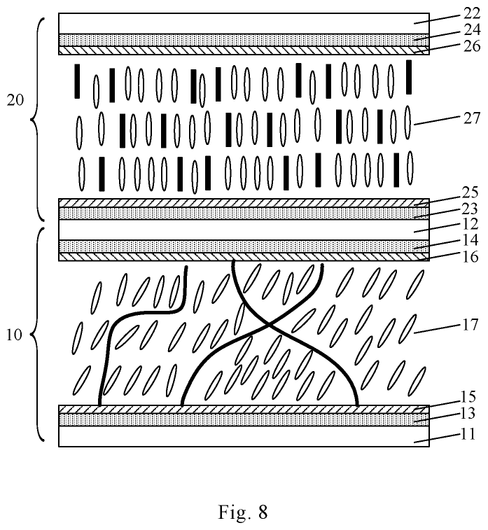

As shown in FIG. 8, an embodiment of the present disclosure further provides a light adjusting glass, which has a structure similar to that of the light adjusting glass in the above embodiment, and the functional light adjusting structure 10 and the basic light adjusting structure 20 of the light adjusting glass each adopt a liquid crystal cell structure, that is, the functional light adjusting structure 10 includes a first base 11 and a second base 12 which are disposed opposite to each other, a first electrode 13 disposed on a side of the first base 11 proximal to the second base 12, a second electrode 14 disposed on a side of the second base 12 proximal to the first base 11, and a first liquid crystal layer 17 interposed between the first electrode 13 and the second electrode 14; the basic light adjusting structure 20 includes a third base 21 and a fourth base 22 which are disposed opposite to each other, a third electrode 23 disposed on a side of the third base 21 proximal to the fourth base 22, a fourth electrode 24 disposed on a side of the fourth base 22 proximal to the third base 21, and a second liquid crystal layer 27 interposed between the third electrode 23 and the fourth electrode 24. The light adjusting glass in the present embodiment is different from the light adjusting glass in the above embodiment in that, in the present embodiment, the second base 12 in the functional light adjusting structure 10 is common to the third base 21 in the basic light adjusting structure 20. That is, the light adjusting glass in the present embodiment can use three bases (e.g., glass bases) without the adhesive layer 30. The light adjusting glass in the present embodiment is simple in structure, and a thickness of the light adjusting glass can be effectively reduced.

It should be noted that, other structures of the light adjusting glass of the present embodiment may adopt the same structures as those in the above embodiment, and therefore, will not be described in detail herein.

The present embodiment further provides a light adjusting glass, which includes a basic light adjusting structure and a functional light adjusting structure, which are disposed in a laminated mode; the functional light adjusting structure may be any functional light adjusting structure described in the above embodiment, and the basic light adjusting structure adopts an electro-chromic structure.

Specifically, the basic light adjusting glass includes a third substrate, a fourth substrate and an electro-chromic layer interposed between the third substrate and the fourth substrate; where the electro-chromic layer controls light to transmit there-through under the control of an electric field generated between the third substrate and the fourth substrate.

The light adjusting glass provided in the present embodiment can achieve the same effects as the light adjusting glass in the above embodiment, and will not be described in detail herein.

The functional light adjusting structure in the present embodiment may include a first base and a second base which are disposed opposite to each other, a first electrode disposed on a side of the first base proximal to the second base, a second electrode disposed on a side of the second base proximal to the first base, and a first liquid crystal layer interposed between the first electrode and the second electrode; the basic light adjusting structure may include a third base and a fourth base which are disposed opposite to each other, a third electrode disposed on a side of the third base proximal to the fourth base, a fourth electrode disposed on a side of the fourth base proximal to the third base, and an electro-chromic layer interposed between the third electrode and the fourth electrode; where the second base is common to the third base. That is, the light adjusting glass in the present embodiment can employ three glass bases without requiring an adhesive layer. The light adjusting glass in the present embodiment is simple in structure, and a thickness of the light adjusting glass can be effectively reduced.

It should be noted that, in the above embodiments, the first electrode and the second electrode in the functional light adjusting structure are plate-shaped electrodes, and the third electrode and the fourth electrode in the basic light adjusting structure are plate-shaped electrodes, but in practical applications, when the liquid crystal molecules are positive liquid crystal molecules, the first electrode and the second electrode can form a TN-type electric field when a voltage is applied therebetween; the first electrode and the second electrode may be both disposed on the first base, in such case, the first electrode and the second electrode are sequentially disposed along a direction away from the first base, the first electrode may be a plate-shaped electrode, the second electrode may be a slit electrode, and when a voltage is applied between the first electrode and the second electrode, an FFS type electric field (or ADS type) may be formed there-between; or the first electrode and the second electrode may be both slit electrodes which are alternately disposed on the first base, and an IPS type electric field may be formed between the first electrode and the second electrode when a voltage is applied therebetween.

Accordingly, an electric field formed between the third electrode and the fourth electrode in the basic light adjusting structure may be the same as that formed between the first electrode and the second electrode in the functional light adjusting structure, and the description thereof is omitted.

It should be understood that the above embodiments are merely exemplary embodiments employed to illustrate the principles of the present disclosure, and the present disclosure is not limited thereto. It will be apparent to those skilled in the art that various changes and modifications can be made therein without departing from the spirit and scope of the present disclosure, and these changes and modifications are to be considered within the scope of the present disclosure.

1. A light adjusting glass, comprising: a basic light adjusting structure and a functional light adjusting structure which are disposed in a laminated manner; wherein,
the basic light adjusting structure and the functional light adjusting structure are cooperated with each other and configured to control a light transmittance of the light adjusting glass,
the base light adjusting structure is different from the functional light adjusting structure.

2. The light adjusting glass of claim 1, wherein the functional light adjusting structure comprises: a first substrate and a second substrate which are disposed opposite to each other; and a first liquid crystal layer interposed between the first substrate and the second substrate; and wherein the first liquid crystal layer is configured to be deflected under an action of an electric field generated between the first substrate and the second substrate, so that the functional light adjusting structure is capable of being in a haze state.

3. The light adjusting glass of claim 1, wherein the first liquid crystal layer comprises polymer network liquid crystal or polymer dispersed liquid crystal.

4. The light adjusting glass of claim 3, wherein the polymer network liquid crystal comprises reverse polymer network liquid crystal.

5. The light adjusting glass of claim 1, wherein the functional light adjusting structure comprises: a first substrate and a second substrate which are disposed opposite to each other; and a first liquid crystal layer interposed between the first substrate and the second substrate; and wherein
the first liquid crystal layer comprises color dye liquid crystal and is configured to be deflected under an action of an electric field generated between the first substrate and the second substrate so as to control a transmittance of light, with the same color as the color dye liquid crystal, irradiated on the functional light adjusting structure.

6. The light adjusting glass of claim 2, wherein the first substrate comprises a first base, and a first electrode disposed on a side of the first base proximal to the first liquid crystal layer;
the second substrate comprises a second base and a second electrode disposed on a side of the second base proximal to the first liquid crystal layer; wherein,
the first electrode and the second electrode are both plate-shaped electrodes.

7. The light adjusting glass of claim 1, wherein the basic light adjusting structure comprises a third substrate, a fourth substrate, and a second liquid crystal layer interposed between the third substrate and the fourth substrate; and wherein,
the second liquid crystal layer includes basic crystal molecules and dichroic dye molecules and is configured to be deflected under the control of an electric field generated between the third substrate and the fourth substrate, so as to control a transmittance of light transmitting there-through.

8. The light adjusting glass of claim 7, wherein the second liquid crystal layer comprises chiral additive therein.

9. The light adjusting glass of claim 7, wherein the third substrate comprises a third base, and a third electrode disposed on a side of the third base proximal to the second liquid crystal layer;
the fourth substrate comprises a fourth base and a fourth electrode disposed on a side of the fourth base proximal to the second liquid crystal layer; wherein,
the third electrode and the fourth electrode are both plate-shaped electrodes.

10. The light adjusting glass of claim 1, wherein the basic light adjusting structure comprises a third substrate, a fourth substrate, and an electro-chromic layer interposed between the third substrate and the fourth substrate; wherein,
the electro-chromic layer controls light to transmit there-through under the control of an electric field generated between the third substrate and the fourth substrate.

11. The light adjusting glass of claim 1, wherein the functional light adjusting structure comprises a first base and a second base which are disposed opposite to each other, a first electrode disposed on a side of the first base proximal to the second base, a second electrode disposed on a side of the second base proximal to the first base, and a first liquid crystal layer interposed between the first electrode and the second electrode;
the basic light adjusting structure comprises a third base and a fourth base which are disposed opposite to each other, a third electrode disposed on a side of the third base proximal to the fourth base, a fourth electrode disposed on a side of the fourth base proximal to the third base, and a second liquid crystal layer interposed between the third electrode and the fourth electrode; and wherein
the second base is common to the third substrate.

12. The light adjusting glass of claim 1, wherein the functional light adjusting structure comprises a first base and a second base which are disposed opposite to each other, a first electrode disposed on a side of the first base proximal to the second substrate, a second electrode disposed on a side of the second base proximal to the first base, and a first liquid crystal layer interposed between the first electrode and the second electrode;
the basic light adjusting structure comprises a third base and a fourth base which are disposed opposite to each other, a third electrode disposed on a side of the third base proximal to the fourth base, a fourth electrode disposed on a side of the fourth base proximal to the third base, and an electro-chromic layer interposed between the third electrode and the fourth electrode; and wherein
the second substrate is common to the third substrate.

13. The light adjusting glass of claim 3, wherein the first substrate comprises a first base, and a first electrode disposed on a side of the first base proximal to the first liquid crystal layer;
the second substrate comprises a second base and a second electrode disposed on a side of the second base proximal to the first liquid crystal layer; wherein,
the first electrode and the second electrode are both plate-shaped electrodes.

14. The light adjusting glass of claim 5, wherein the first substrate comprises a first base, and a first electrode disposed on a side of the first base proximal to the first liquid crystal layer;
the second substrate comprises a second base and a second electrode disposed on a side of the second base proximal to the first liquid crystal layer; wherein,
the first electrode and the second electrode are both plate-shaped electrodes.
